(19) United States
(12) Patent Application Publication
(10) Pub. No.: US 2011/0070006 A1
(43) Pub. Date: Mar. 24, 2011

(54) TEMPERATURE EQUALIZING ROLLER AND FIXING DEVICE

(75) Inventors: Toshihiro Sone, Kanagawa-ken (JP); Kazuhiko Kikuchi, Kanagawa-ken (JP); Satoshi Kinouchi, Tokyo (JP); Hiroshi Nakayama, Shizuoka-ken (JP); Hiroyuki Kunugi, Shizuoka-ken (JP); Setsuo Takada, Shizuoka-ken (JP); Shuji Yokoyama, Shizuoka-ken (JP); Yoshiaki Okano, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 12/885,389

(22) Filed: Sep. 17, 2010

Related U.S. Application Data
(60) Provisional application No. 61/244,728, filed on Sep. 22, 2009.
(60) Provisional application No. 61/244,737, filed on Sep. 22, 2009.

(51) Int. Cl. G03G 15/20

(52) U.S. Cl. 399/333

(57) ABSTRACT

A temperature equalizing roller includes a metal pipe, a heat pipe that is located inside the metal pipe and has a thermal expansion coefficient higher than that of the metal pipe, and a joining layer. The joining layer lies between an outer peripheral surface of the heat pipe and an inner peripheral surface of the metal pipe, joins the outer peripheral surface of the heat pipe and the inner peripheral surface of the metal pipe, and has a higher thermal conductivity than a thermal conductivity of air.

### CROSS-REFERENCE TO RELATED APPLICATION

This application is based upon and claims the benefit of priority from: U.S. provisional application 61/244,728, filed on Sep. 22, 2009; U.S. provisional application 61/244,737, filed on Sep. 22, 2009; the entire contents all of which are incorporated herein by reference.

### FIELD

Embodiments described herein relate generally to a technique to improve equalizing temperature performance of a temperature equalizing roller.

### BACKGROUND

Hitherto, a fixing device is used which includes a heat roller to heat toner transferred on a sheet and a pressure roller to pressure bond the toner to the sheet by nipping the sheet in cooperation with the heat roller. The fixing device includes a passing part through which the sheet passes in an axial direction of the heat roller and a non-passing part through which the sheet does not pass. Since the heat of the passing part is absorbed by the passing sheet, and a large temperature difference occurs between the passing part and the non-passing part, and a large temperature unevenness can occur in heating temperature applied to the sheet in the axial direction of the heat roller. The temperature unevenness causes a color unevenness of an image formed on the sheet. Concerning this problem, a technique is known in which a heat pipe is provided in the inside of a heat roller to suppress the large temperature unevenness from occurring in the heat roller, and the heating temperature applied to the sheet is equalized in the axial direction of the heat roller.

Besides, as a technique to equalize the heating temperature, a technique is known in which a tension roller including a heat pipe is provided, and a belt is wound around the tension roller and the heat roller. In this technique, the heat roller heats the belt. The heated belt heats the sheet. At that time, the tension roller equalizes the temperature unevenness of the belt generated by heating the sheet. Since the belt the temperature unevenness of which is equalized heats the sheet, the heat applied to the sheet can be equalized in the rotation axis direction of the roller.

In recent years, with the improvement of the performance of an image forming apparatus, a temperature equalizing roller capable of equalizing the heat at higher speed and a fixing device including the same are required.

### DESCRIPTION OF THE DRAWINGS

FIG. 1 is a sectional view of an image forming apparatus of a first embodiment.

FIG. 2 is a perspective view showing a fixing device.

FIG. 3 is a sectional view of a tension roller in an axial direction.

FIG. 4 is a sectional view of the tension roller perpendicular to the axial direction.

FIG. 5 is a sectional view showing a state before joining of a metal pipe and a heat pipe.

FIG. 6 is a flowchart for explaining a manufacturing method of the tension roller.

FIG. 7 is a view showing a temperature distribution of a belt when an A4-R sheet passes through a fixing device.

FIG. 8 is a sectional view showing a metal pipe of a second embodiment.

FIG. 9 is a view showing a state where a heat pipe is fitted in the metal pipe.

FIG. 10 is a sectional view showing a tension roller.

FIG. 11 is a sectional view showing a metal pipe of a third embodiment.

FIG. 12 is a sectional view showing a metal pipe of a fourth embodiment.

FIG. 13 is a sectional view showing a tension roller.

FIG. 14 is a sectional view of a tension roller of a fifth embodiment in an axial direction.

FIG. 15 is a sectional view showing a fixing device of a sixth embodiment.

FIG. 16 is a perspective view showing a pressure pad.

FIG. 17 is a plan view showing a peeling plate.

FIG. 18 is a sectional view showing a structure of the peeling plate.

FIG. 19 is a plan view showing a peeling member of a modified example.

### DETAILED DESCRIPTION

In general, according to an embodiment, a temperature equalizing roller includes a metal pipe, a heat pipe that is located inside the metal pipe and comprises a thermal expansion coefficient higher than that of the metal pipe, and a joining layer that lies between an outer peripheral surface of the heat pipe and an inner peripheral surface of the metal pipe, joins the outer peripheral surface of the heat pipe and the inner peripheral surface of the metal pipe, and comprises a higher thermal conductivity than a thermal conductivity of air.

Besides, according to an embodiment, a temperature equalizing roller includes a metal pipe that comprises a tubular shape and comprises an inner peripheral length longer than a peripheral length of a circle comprising a radius which is an average inner radius, and a heat pipe that is in close contact with an inner peripheral surface of the metal pipe and comprises a thermal expansion coefficient higher than that of the metal pipe.

Besides, according to an embodiment, a fixing device includes a metal pipe of any of a heating rotator to heat a sheet on which toner is transferred, a rotator to feed a sheet in cooperation with the heating rotator, or a rotator to rotate a belt wound around itself and the heating rotator, a heat pipe that is located inside the metal pipe and has a thermal expansion coefficient higher than that of the metal pipe, and a joining layer that lies between an outer peripheral surface of the heat pipe and an inner peripheral surface of the metal pipe, joins the outer peripheral surface of the heat pipe and the inner peripheral surface of the metal pipe, and has a higher thermal conductivity than a thermal conductivity of air.

Hereinafter, embodiments will be described with reference to the drawings.

### First Embodiment

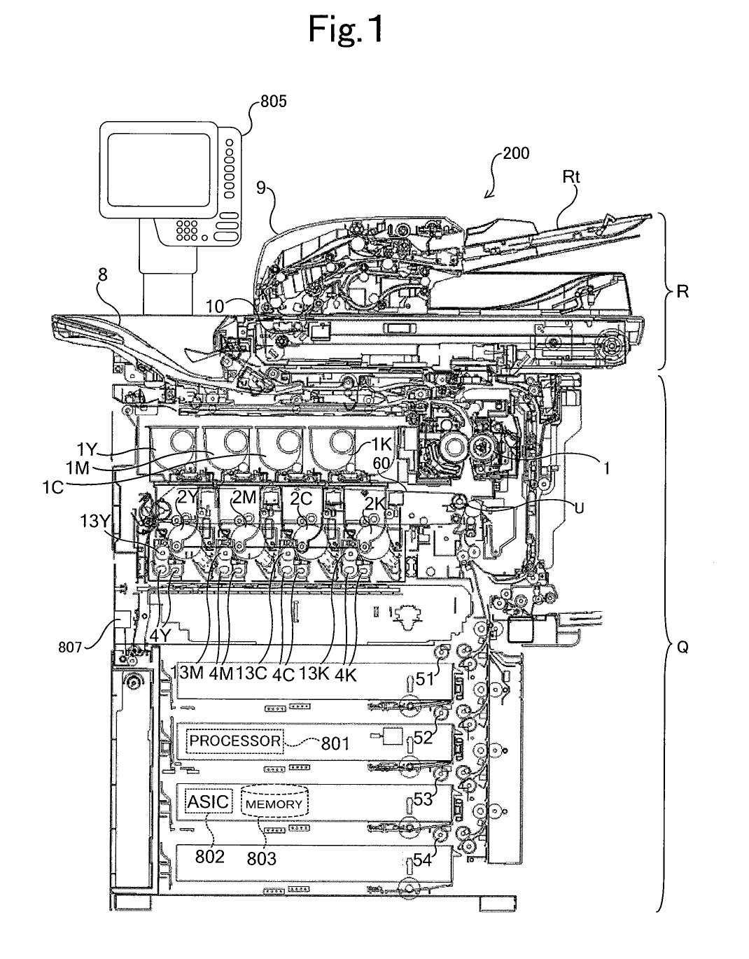

FIG. 1 is a sectional view showing an image forming apparatus 200 of an embodiment.

The image forming apparatus 200 includes an image reading section R and an image forming section P. The image reading section R scans and reads an image of a sheet document and a book document.

The image forming section P forms a toner image on a sheet based on the image read from the document by the image reading section R or print data transmitted to the image forming apparatus 200 from an external equipment.

The image reading section R includes an auto document feeder (ADF) 9 to automatically feed a document to a specified image read position, and reads an image of a document placed on a document tray (specified document placing table) Rt, which is automatically fed by the auto document feeder 9, or an image of a document placed on a not-shown document table by a scanning optical system 10.

The image forming section P includes toner cartridges 1Y to 1K, pickup rollers 51 to 54, photoreceptors 2Y to 2K, development rollers 3Y to 3K, mixers 4Y to 4K, an intermediate transfer belt 60, a fixing device 100 and a discharge tray 8.

Besides, the image forming apparatus 200 of this embodiment includes a processor 801, an ASIC circuit 802, a memory 803, an operation display section 805 and a communication section 807.

The processor 801 serves to perform various processes in the image forming apparatus 200, and serves to realize various functions by executing programs stored in the memory 803. The memory 803 may be, for example, a RAM (Random Access Memory), a ROM (Read Only Memory), a DRAM (Dynamic Random Access Memory), an SRAM (Static Random Access Memory) or a VRAM (Video RAM), and serves to store various information and programs used in the image forming apparatus 200.

Various settings are displayed on the operation display section 805. The operation display section 805 may be an LCD (Liquid Crystal Display), an EL (Electronic Luminescence), a PDP (Plasma Display Panel) or a CRT (Cathode Ray Tube).

The various settings are changed by operating the operation display section 805. The operation display section 805 may be of a touch panel type.

Hereinafter, the outline of a copy process will be described as an example of a process in the image forming apparatus 200.

First, a sheet picked up by pickup rollers 51 to 54 from a cassette is supplied to a sheet conveyance path. The sheet supplied into the sheet conveyance path is conveyed by plural roller pairs toward a specified conveyance direction.

The scanning optical system 10 reads images of plural sheet documents continuously automatically fed by the auto document feeder 9 at the specified image read position.

Next, electrostatic latent images are formed on the photosensitive surfaces of the photoreceptors 2Y, 2M, 2C and 2K for transferring toner images of yellow (Y), magenta (M), cyan (C) and black (K) to the sheet based on the print data of the image read from the document by the image reading section R.

Subsequently, toner agitated by the mixers 4Y to 4K in the developing device is supplied by the development rollers 3Y to 3K to the photoreceptors 2Y to 2K on which the electrostatic latent images are formed. By this, the electrostatic latent images formed on the photosensitive surfaces of the photoreceptors are developed.

The toner images formed on the photoreceptors in this way are transferred (so-called primary transfer) onto the belt surface of the intermediate transfer belt 60, and the toner images conveyed by rotation of the intermediate transfer belt are transferred onto the conveyed sheet at a specified secondary transfer position T.

The toner images transferred on the sheet are heated and fixed to the sheet in the fixing device 1. The sheet on which the toner images are heated and fixed is conveyed in the conveyance path by plural conveyance roller pairs, and is sequentially discharged onto the discharge tray 8.

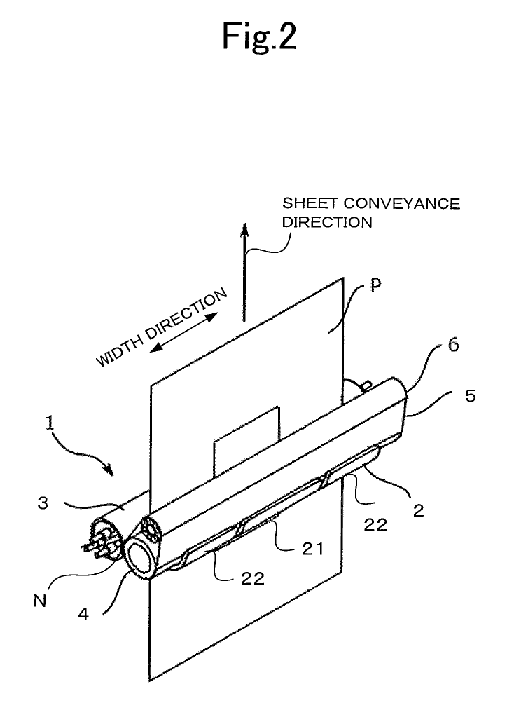

FIG. 2 is a perspective view showing the fixing device 1.

The fixing device 1 heats and pressurizes the toner transferred on the sheet P and fixes the toner to the sheet P. For example, a paper or an OHP sheet can be adopted as the sheet P.

The fixing device 1 includes an IH coil 2, a pressure roller 3, a fixing roller 4, a belt 5 and a tension roller 6 as a temperature equalizing roller.

The IH coil 2 is adjacent to the fixing roller 4 over the whole area of the fixing roller 4 in the axial direction, and generates a magnetic flux. The IH coil 2 includes an IH coil 21 to heat the center part of the fixing roller 4 in the axial direction, and IH coils 22 to heat both ends of the fixing roller 4 in the axial direction. The IH coils 21 and 22 are independently controlled. The width of the IH coil 21 corresponds to the width of 210 mm of the A4-R size sheet P.

When the sheet P of a size of from the minimum size (for example, postcard size) to the A4-R size, which is a fixing process object, is made to pass through the fixing device 1, current is applied only to the center IH coil 21, and heats an area of the fixing roller 4 corresponding to the width (size in the rotation axis direction of the tension roller 6) of the A4-R size sheet P. When the sheet P of a width larger than the A4-R size sheet P, for example, the Ledger size sheet P of a width of 279 mm is made to pass through the fixing device 1, the width of the Ledger size sheet P is wider than the heating range of the center IH coil 21. Thus, in addition to the center IH coil 21, current is applied also to the IH coils 22 at both sides of the IH coil 21, and the whole area of the fixing roller 4 in the axial direction is heated.

Incidentally, the heating range of the center IH coil 21 has only to be wider than the width of the minimum size sheet P as the fixing process object. When the heating range of the IH coil 21 is narrower than the width of the minimum size sheet P as the fixing process object, it becomes necessary to apply current to all the IH coils 21 and 22, and it becomes meaningless to divide the IH coil 2.

The pressure roller 3 comes in press contact with the fixing roller 4 through the belt 5, and forms a nip N. The pressure roller 3 is driven and rotated by the rotating fixing roller 4.

The fixing roller 4 includes a core metal and an elastic layer in sequence from the inside. The fixing roller 4 generates heat by the change of the magnetic flux generated by the IH coil, and heats the belt 5. Besides, the fixing roller 4 nips the sheet P in cooperation with the pressure roller 3 through the belt 5, and conveys the sheet P in an arrow direction of FIG. 2 in cooperation with the pressure roller 3 while rotating.

The belt 5 is an endless belt, and is wound around the fixing roller 4 and the tension roller 6. The belt 5 is heated by the fixing roller 4. The heated belt 5 heats the sheet P. The fixing device 1 heats the sheet P by the belt 5 at the nip N, and fixes the toner to the sheet P by pressing of the pressure roller 3 and the fixing roller 4.

The tension roller 6 suppresses the temperature unevenness of the belt 5 in the width direction. Besides, the elastic member such as a coil spring or a plate spring urges the tension roller 6, so that the tension roller 6 applies tension to the belt 5.

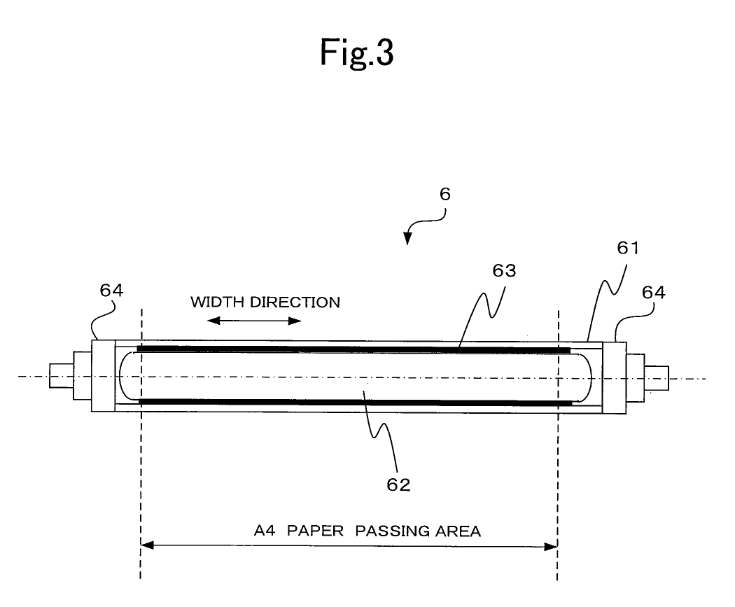

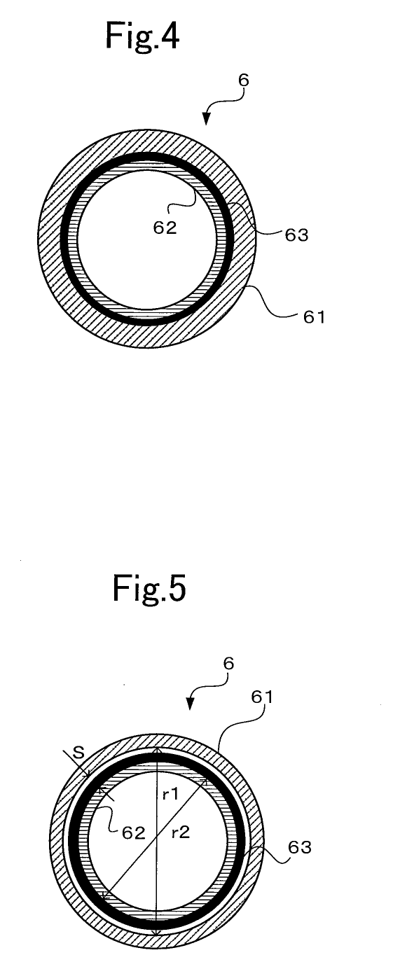

FIG. 3 is a sectional view of the tension roller 6 in the axial direction, and FIG. 4 is a sectional view of the tension roller 6 in a direction perpendicular to the axial direction.

The tension roller 6 includes a metal pipe 61, a heat pipe 62, a joining layer 63 and shaft members 64.

The metal pipe 61 can be made of, for example, iron for reduction of cost. Besides, when the metal pipe 61 is made of iron, the pipe can be made thin while the strength is kept. The material of the metal pipe 61 may be stainless. The metal pipe made of stainless may produce the same effect as that of the metal pipe made of iron. The material of the metal pipe 61 may be aluminum. When the metal pipe 61 is made of aluminum, as compared with the case where the metal pipe 61 is made of iron or stainless, the thermal conductivity can be improved.

The heat pipe 62 is such that volatile hydraulic fluid is sealed in a pipe made of metal such as, for example, copper, and dissipates the absorbed heat from a portion shifted in the axial direction. The heat pipe 62 is located inside the metal pipe 61, and the outer peripheral surface of the heat pipe 62 is in close contact with the inner peripheral surface of the metal pipe 61. The heat pipe 62 equalizes the temperature unevenness of the belt 5 in the width direction through the metal pipe 61. The heat pipe 62 is made of copper, and has a thermal expansion coefficient higher than that of the metal pipe 61. It is needless to say that as the material of the heat pipe 62, a metal other than copper can be adopted as long as its thermal expansion coefficient is higher than that of the material of the metal pipe 61.

The joining layer 63 lies between the outer peripheral surface of the heat pipe 62 and the inner peripheral surface of the metal pipe 61, and joins the outer peripheral surface of the heat pipe 62 and the inner peripheral surface 61 of the metal pipe and has a higher thermal conductivity than that of air. In the pipes 61 and 62, the joining layer 63 is provided in an area longer than the width of 297 mm of the A4 size as the maximum size of the fixing process object. The joining layer 63 has a melting point lower than a temperature required to join the metal pipe 61 and the heat pipe 62 by using thermal expansion of the heat pipe 62 caused by heating the metal pipe 61 and the heat pipe 62. The temperature required to join the metal pipe 61 and the heat pipe 62 is lower than a temperature at which the metal pipe 61 on the outer side is ruptured by thermal expansion of the heat pipe 62 on the inner side and is higher than a temperature at which the joining layer 63 fills the gap between the metal pipe 61 on the outer side and the heat pipe 62 on the inner side due to thermal expansion of the heat pipe 62.

As the material of the joining layer 63, in this embodiment, a solder containing silver having a high thermal conductivity as an additive is adopted as an example. Incidentally, as the material of the joining layer 63, it is needless to say that another material can be adopted as long as the melting point is lower than the temperature required to join the metal pipe 61 and the heat pipe 62.

The shaft members 64 are coupled to both ends of the metal pipe 61. The shaft members 64 are supported by bearings or the like, and the tension roller 6 rotates.

FIG. 5 is a sectional view showing a state before joining of the metal pipe 61 and the heat pipe 62.

The metal pipe 61 has an inner diameter r1 of 16.1±0.2 mm and a thickness of 0.3 mm.

The heat pipe 62 has an outer diameter r2 of 15.88 mm. The joining layer 63 is laminated on the outer peripheral surface of the heat pipe 62 in an area longer than the width of 297 mm of the A4 sheet which is the maximum sheet P as the toner fixing process object (FIG. 3). The thickness of the joining layer 63 is desirably 10 to 100 p.m. When the thickness is excessively large, the layer becomes resistance against the heat conduction between the metal pipe 61 and the heat pipe 62.

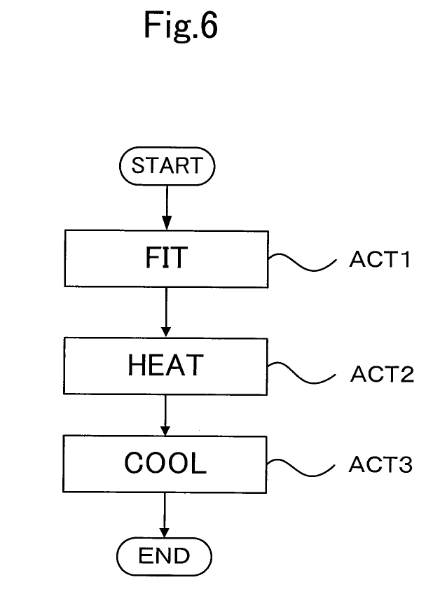

A manufacturing method of the tension roller 6 including the metal pipe 61 and the heat pipe 62 will be described with reference to a flowchart of FIG. 6.

First, an operator fits the heat pipe 62 into the inside of the metal pipe 61 (ACT 1). At this time, a gap S (FIG. 5) of 0.1 to 0.5 mm is generated between the heat pipe 62 and the inner peripheral surface of the metal pipe 61.

After ACT 1, the operator heats both the pipes 61 and 62 at 300 to 400° C. for 1 to 4 hours to perform metal joining (ACT 2). The heat pipe 62 is made of copper, and has a thermal expansion coefficient higher than that of the metal pipe 61 made of iron. Thus, when both the pipes 61 and 62 are heated at 300 to 400° C. for 1 to 4 hours, the heat pipe 62 is expanded and comes in press contact with the metal pipe 61, and metal joining is performed. At this time, since the joining layer 63 is made of solder and the melting point is lower than the junction temperature of 300 to 400° C. of both the pipes 61 and 62, the joining layer becomes liquid. The liquid joining layer 63 expands into the gap S between the metal pipe 61 and the heat pipe 62.

After ACT 2, the operator cools the metal pipe 61, the heat pipe 62 and the joining layer 63 by, for example, natural cooling (ACT 3). By this, the joining layer 63 becomes a solid in the gap S between the pipes 61 and 62 and fills the gap S. The tension roller 6 can be manufactured by the above process of ACT 1 to ACT 3.

In the tension roller 6 of this embodiment manufactured by the process of ACT 1 to ACT 3, since the gap S is filled with the joining layer 63, as compared with the related art tension roller in which air exists in the gap S, the thermal conductivity between the metal pipe 61 and the heat pipe 62 is improved. At the same time, the heat transport efficiency of the tension roller 6 in the axial direction is improved as compared with the related art. Thus, since the fixing device 1 including the tens ion roller 6 suppresses the temperature unevenness of the belt 5 and equalizes the temperature unevenness of the heat temperature applied to the sheet P, the color unevenness generated on an image can be suppressed.

Besides, the fixing device 1 can efficiently transport the heat at both ends of the belt 5 as the non-passing area of the sheet P to the center part of the belt 5 as the passing area of the sheet P. Thus, in the fixing device 1 of this embodiment, the output of the IH heater 21 to heat the center part of the fixing roller 4 is reduced and the total electric power can be reduced. Thus, an energy-saving effect can be obtained. Further, in the fixing device 1 of this embodiment, the above remarkable effect can be obtained without decreasing or increasing the related art components (the pressure roller, the fixing roller, the belt and the tension roller) and without significantly increasing the cost for manufacturing the tension roller as compared with the related art.

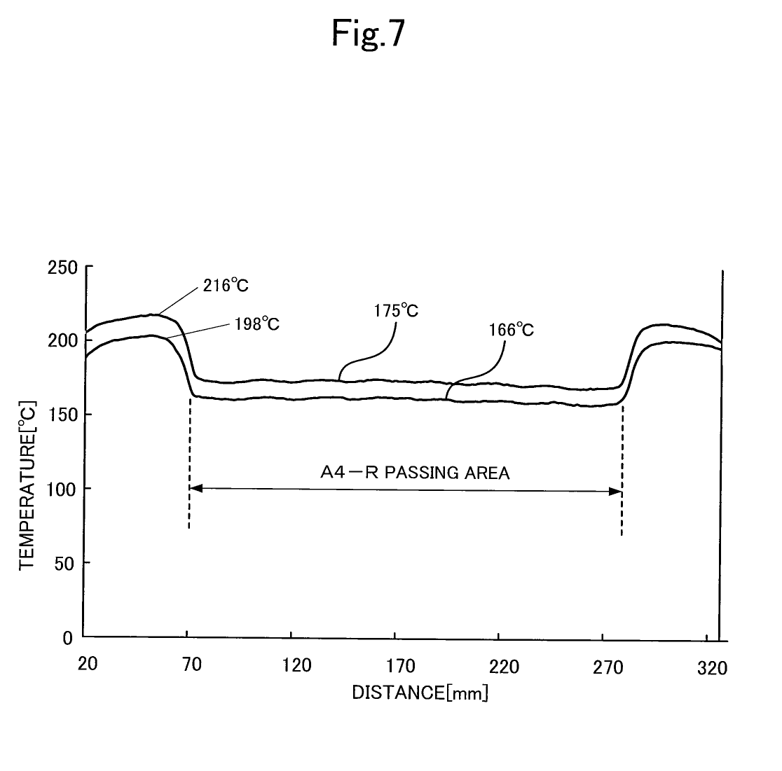

FIG. 7 is a view showing a temperature distribution of the belt 5 when the A4-R sheet P passes through the fixing device 1.

A performance test is performed on a related art tension roller in which a joining layer does not exist in a gap between a metal pipe and a heat pipe and the tension roller 6 of this embodiment in which the joining layer 63 exists in the gap S between the pipes 61 and 62.

First, the related art tension roller is assembled in the fixing device 1, the surface temperature of the sheet passing area of the belt 5 is kept at 175° C., and the A4-R size sheet P having a width of 210 mm is made to continuously pass through the fixing device 1. Then, the temperature distribution of the surface of the belt 5 in the width direction is measured. As shown in FIG. 7, the temperature of the non-passing area of the sheet P in the belt 5 is 216° C., the temperature of the passing area of the sheet P is 175° C., and the temperature difference between both the areas is 39° C.

Next, the tension roller 6 of this embodiment is assembled in the fixing device 1, the same performance test is performed, and the temperature distribution of the surface of the belt 5 is measured. As shown in FIG. 7, the temperature of the non-passing area of the sheet P in the belt 5 is 198° C., the temperature of the passing area of the sheet P is 175° C., and the temperature difference between both the areas is 23° C.

From the above test results, it is confirmed that as compared with the related art fixing device, in the tension roller 6 of this embodiment, the heat of the non-passing area of the sheet P in the belt 5 is efficiently transported to the passing area of the sheet P, and the temperature unevenness of the belt 5 can be more equalized. Then, it is confirmed that as compared with the related art tension roller, in the tension roller 6 of this embodiment, the thermal conductivity between the metal pipe 61 and the heat pipe 62 is excellent, and the heat transport efficiency in the axial direction is excellent, that is, the equalizing temperature performance is excellent.

### Second Embodiment

Hereinafter, the same functional part as that of the first embodiment is denoted by the same reference numeral and the explanation of the same functional part will be omitted.

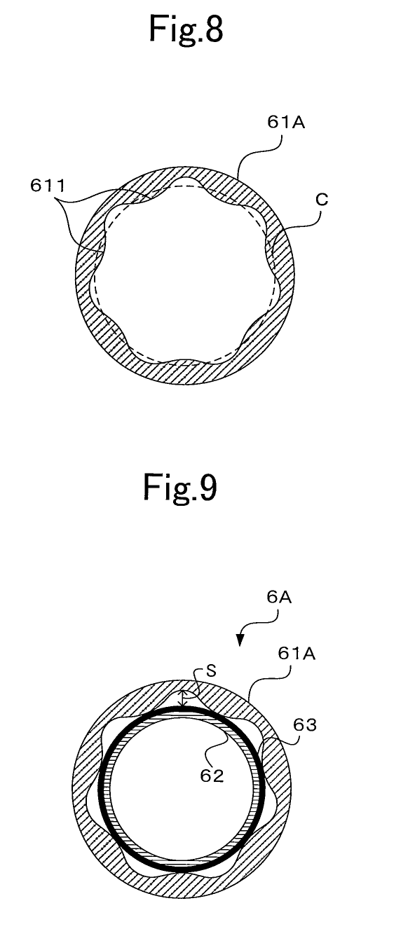

FIG. 8 is a sectional view showing a metal pipe 61A of a tension roller of a second embodiment.

In the first embodiment, the inner periphery of the metal pipe 61A has a circular shape. However, in this embodiment, plural grooves 611 extending in an axial direction of the metal pipe 61A are formed on the inner peripheral surface of the metal pipe 61A, and the inner periphery of the metal pipe 61A is corrugated by these grooves 611. The depth of the groove 611 is set to be 7% or more of the thickness of the metal pipe 61A. In the metal pipe 61A, its inner peripheral length is longer than the peripheral length of a circle C having a radius equal to an average inner radius. Another component of the tension roller of this embodiment is the same as that of the first embodiment.

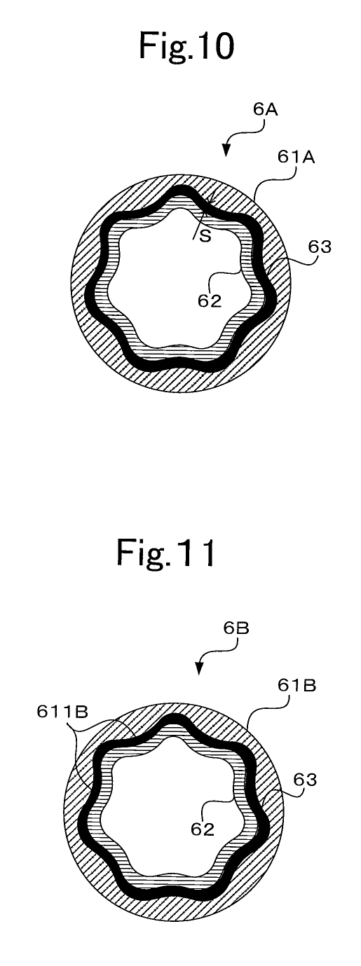

Also in this embodiment, when the tension roller 6A is manufactured, first, the operator fits a heat pipe 62 into the inside of the metal pipe 61A (FIG. 9). At this time, a gap S is generated between the heat pipe 62 and the inner peripheral surface of the metal pipe 61A. Next, the operator heats both the pipes 61A and 62 to perform metal joining. At this time, a joining layer 63 of solder becomes liquid and expands into the gap S between the pipes 61A and 62. Next, the operator cools the pipes 61A and 62 and the joining layer 63. By this, as shown in FIG. 10, the joining layer 63 is solidified to fill the gap S, and the tension roller 6 is manufactured.

Since this embodiment has the same structure as the first embodiment, the same effect as the first embodiment can be obtained. Further, in this embodiment, in the metal pipe 61A, since the inner peripheral length is longer than the peripheral length of the circle C having the radius equal to the average inner radius, the joining area between the metal pipe 61A and the heat pipe 62 is increased, and the metal pipe 61A and the heat pipe 62 can be more firmly joined. By this, the thermal conductivity between the metal pipe 61A and the heat pipe 62 is improved, and the thermal conductivity of the tension roller 6A in the axial direction is improved more than the first embodiment. Thus, in this embodiment, the equalizing temperature performance of the tension roller 6A can be improved more than the first embodiment.

### Third Embodiment

FIG. 11 is a sectional view showing a metal pipe 61B of a third embodiment.

In the second embodiment, the plural grooves 611 on the inner peripheral surface of the metal pipe 61A extend in the axial direction of the metal pipe 61A. In this embodiment, a groove 611B is formed to have a spiral shape while the center axis of the metal pipe 61B is the center axis of the spiral.

In this embodiment, since the groove 611B has the spiral shape, even when the joint between the metal pipe 61B and the heat pipe 62 becomes weak, the metal pipe 61B and the heat pipe 62 does not immediately come off from each other in the axial direction.

### Fourth Embodiment

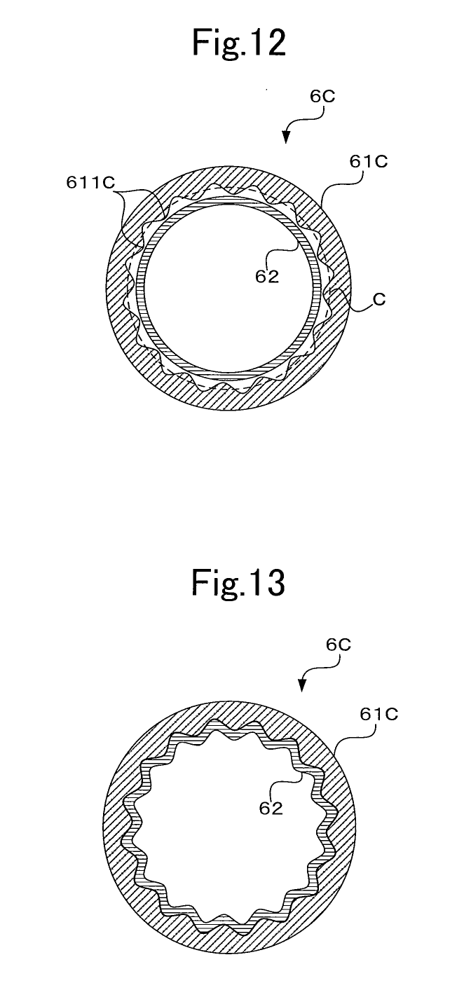

FIG. 12 is a sectional view showing a metal pipe 61C of a fourth embodiment.

In a tension roller 6C of this embodiment, grooves 611C are formed on an inner peripheral surface of the metal pipe 61C more thickly than the third embodiment, and a joining layer is not provided. Also in the metal pipe 61C of this embodiment, its inner peripheral length is longer than the peripheral length of a circle C having a radius equal to an average inner radius.

When the tension roller 6C is manufactured, first, the operator fits a heat pipe 62 into the inside of the metal pipe 61C. Next, the operator heats both the pipes 61C and 62 to perform metal joining as shown in FIG. 13, and then, the metal pipe 61C and the heat pipe 62 are cooled.

In this embodiment, since the inner periphery of the metal pipe 61C is corrugated, the joining area between the metal pipe 61C and the heat pipe 62 is increased, and the metal pipe 61C and the heat pipe 62 can be joined more closely than the related art. Thus, in this embodiment, even if a joining layer does not exist, the thermal conductivity between the metal pipe 61C and the heat pipe 62 can be improved, the heat transport efficiency of the tension roller 6C in the axial direction can be improved, and the equalizing temperature performance of the tension roller 6C can be improved as compared with the related art. Accordingly, the fixing device including the tension roller 6C equalizes the temperature unevenness of the belt 5, and can suppress the color unevenness from occurring on an image. Besides, in the fixing device, the tension roller 6C can efficiently transport the heat at both ends of the belt 5 to the center part, the output of an IH heater 21 to heat the center part is reduced, and the total electric power can be reduced.

### Fifth Embodiment

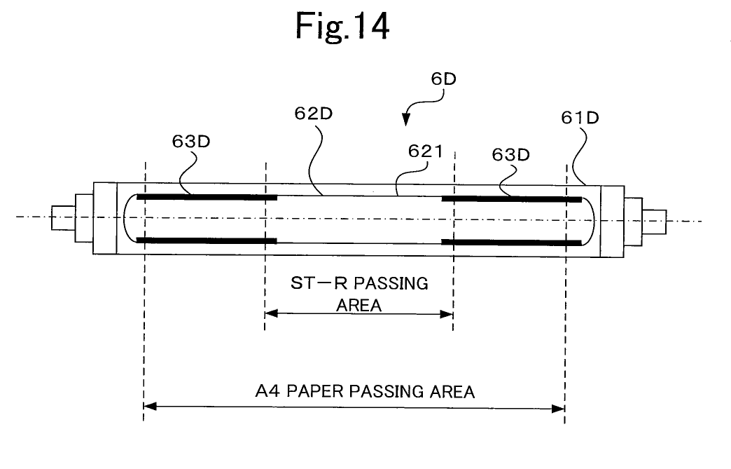

FIG. 14 is a sectional view of a tension roller 6D of a fifth embodiment in an axial direction.

In the first to the third embodiments, the joining layer 63 is laminated on the whole area of the heat pipe 62 in the axial direction. In this embodiment, joining layers 63D are separately laminated at positions close to both ends of a heat pipe 62D in the axial direction, and are positioned.

The distance between ends of both areas of the joining layers 63D, which are positioned to be separate from each other, close to the center of the tension roller 6D in the axial direction is shorter than a width of 140 mm of the statement (ST-R) paper which is the minimum sheet P as the toner fixing process object. Besides, the distance between the outside ends of both the areas is longer than a width of 297 mm of the A4 sheet which is the maximum sheet P as the toner fixing process object.

Besides, in this embodiment, the heat pipe 62D includes a surface protection member 621. In the surface protection member 621, the thermal conductivity of both end sides in the axial direction of the heat pipe 62D is higher than the thermal conductivity of the center part.

Further, in this embodiment, in a metal pipe 61D, the thickness of the center part in the axial direction is larger than that of both ends.

By the above structure, in this embodiment, the thermal conductivity from the metal pipe 61D to the heat pipe 62D in the non-passing area of the sheet P can be improved as compared with the related art, and the equalizing temperature performance of the tension roller 6D can be improved. Thus, the fixing device including the tension roller 6D can efficiently transport the heat at both ends of the belt 5 to the center part by the tension roller 6D, equalizes the temperature unevenness of the belt 5, and can suppress the color unevenness from occurring on an image.

### Modified Examples of the First to the Fifth Embodiments

In the second to the fourth embodiments, the grooves 611 to 6110 are provided on the inner peripheral surfaces of the metal pipes 61A to 61C in the axial direction, so that the areas of the inner peripheral surfaces of the metal pipes 61A to 61C are increased, and the strength of the metal joining between the heat pipe 62 and the metal pipes 61A to 61C is improved. However, the method of providing the grooves on the inner peripheral surface of the metal pipe may not be adopted as the method of increasing the area of the inner peripheral surface of the metal pipe. As the method of increasing the area of the inner peripheral surface of the metal pipe, for example, plural protrusions each having a height lower than the thickness of the metal pipe are provided on the inner peripheral surface of the metal pipe, and concave portions may be provided between the projections. The corner parts of the projections and the concave portions are round. The area of the inner peripheral surface of the metal pipe may be increased by the projections and the concave portions.

In the first to the third and the fifth embodiments, although the joining layer 63, 63D is laminated on the heat pipe 62, 62D side, the joining layer may be laminated on the inner peripheral surface side of the metal pipe.

In the first to the fifth embodiments, the description is made on the example in which the temperature equalizing roller is applied as the tension roller which is the rotator to rotate the belt wound around itself and the fixing roller. However, the temperature equalizing roller may be provided for the fixing roller as a heating rotator to heat a sheet on which toner is transferred. Besides, the temperature equalizing roller may be provided for the pressure roller as a rotator to feed a sheet in cooperation with the heating rotator.

### Sixth Embodiment

Hitherto, a heating apparatus is known in which a heating rotator and a rotator which is in press contact with the heating rotator nip a sheet on which toner is transferred, so that the sheet is heated and pressed. In this type of heating apparatus, since the toner on the sheet is melted by heat, the sheet becomes liable to be wound around the heating rotator by the melted toner. As a measure against this, a technique is known in which a peeling member whose tip contacts with a surface of a heating rotator is provided in a heating apparatus, and the peeling member peels a sheet from the heating rotator.

However, in the related art, since the tip of the peeling member contacts with the heating rotator, there is a fear that the peeling member may damage the surface of the heating rotator.

Also in the follow description of this embodiment, the same functional part as that of the first embodiment is denoted by the same reference numeral and the explanation of the same functional part will be omitted.

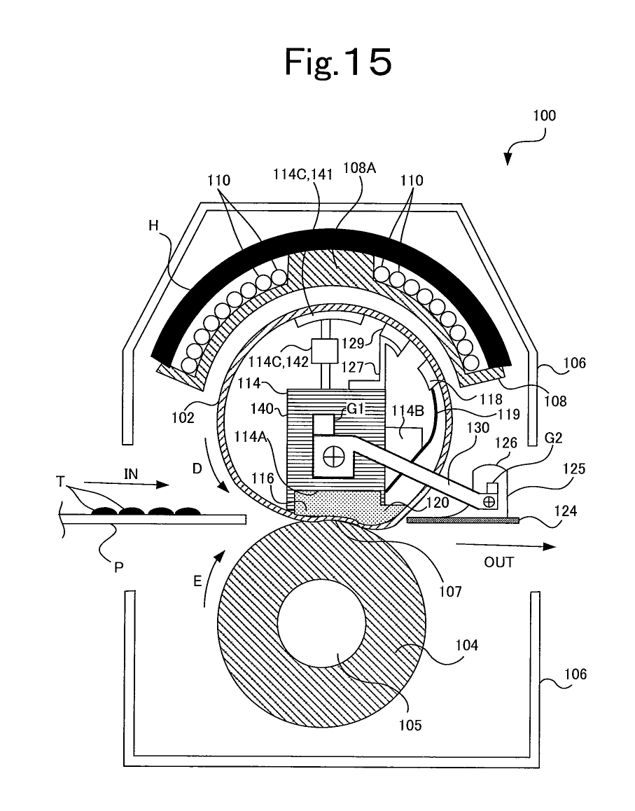

FIG. 15 is a sectional view showing a fixing device 100 of this embodiment.

The fixing device 100 includes a pressure roller 104, a metal belt 102, an IH coil 110 as a heating unit, a base member 114, a pressure pad 116 as a pressing member, an opposite member 120, a peeling member 125, a coupling member 130 and a housing 106 containing the members 102 to 130.

The pressure roller 104 includes a core metal 105 made of a metal such as aluminum, silicone rubber to cover the core metal 105 and PFA, and has a longish shape. The pressure roller 104 is rotated in an arrow E direction by a drive motor.

The IH coil 110 is provided along the outer peripheral surface of the metal belt 102, and generates a magnetic field H by energization. The IH coil 110 may not be divided or may be divided. Besides, the IH coil 110 may lie in the space inside the metal belt 102. In this embodiment, although the IH coil 110 is used as a heating unit to heat the belt, a halogen lamp or a ceramic heater may be used as a heating unit.

The metal belt 102 includes a heat generation layer. The heat generation layer is formed of a metal material, and generates heat by eddy current generated by electromagnetic induction of the IH coil 110. The metal belt 102 has an endless shape, and tension is applied by the pressure pad 116 and the base member 114. The metal belt 102 rotates in an arrow D direction by rotation of the pressure roller 104. The metal belt 102 nips and conveys the sheet P on which toner T is transferred in cooperation with the pressure roller 104. A contact portion between the metal belt 102 and the pressure roller 104 is hereinafter referred to as a nip 107.

The base member 114 is positioned in the space inside the metal belt 102, and supports the pressure pad 116. The base member 114 is made of aluminum as a non-magnetic substance. The base member 114 has a longish shape extending in the width direction of the metal belt 102 at the inside of the metal belt 102. The base member 114 includes a main body part 140, a tension variable mechanism 114C, a protrusion 114B and a support member 127.

Both ends of the main body part 140 in the longitudinal direction are fixed to the housing 106. In the main body part 140, a surface opposite to the pressure roller 104 has a recess 114A in the longitudinal direction of the main body part 140. The pressure pad 116 is fixed to the recess 114A.

The tension variable mechanism 114C supports apart opposite to a part pressed by the pressure pad 116 on the inner peripheral surface of the metal belt 102. The tension variable mechanism 114C includes a support part 141 and an arm part 142. The support part 141 guides the inner peripheral surface of the metal belt 102. One end of the arm part 142 is connected to the main body part 140, and the other end is connected to the support part 141. The arm part 142 includes an actuator and expands and contracts.

The tension variable mechanism 114C expands and contracts the arm part 142 under the control of the processor 801, and changes the tension applied to the metal belt 102. For example, when the fixing device 100 performs a fixing process on a thick sheet P, the tension variable mechanism 114C shortens the arm part 142 and weakens the tension applied to the metal belt 102. Then, the width of the nip 107 becomes wide, and the heating and pressing time of the sheet P by the metal belt 102 and the pressure roller 104 becomes long. Thus, even if the sheet P is thick, the fixing device 100 can certainly perform the fixing process of the toner T. On the other hand, when the fixing device 100 performs the fixing process on a thin sheet P, the tension variable mechanism 114C lengthens the arm part 142, and intensifies the tension applied to the metal belt 102. Then, the width of the nip 107 becomes narrow, and the heating and pressing time of the sheet P by the metal belt 102 and the pressure roller 104 becomes short. Thus, the fixing device 100 can prevent excessive heating to the sheet P.

The protrusion 114B is fixed to the side surface of the main body part 140. The protrusion 114B supports a temperature sensor 118 through a plate spring 119. The temperature sensor 118 detects the surface temperature of the metal belt 102 in a non-contact manner. The processor 801 controls the IH coil 110 based on the surface temperature of the metal belt 102 detected by the temperature sensor 118, and controls the temperature of the metal belt 102. The temperature sensor to detect the surface temperature of the metal belt 102 may be of a contact type or a thermopile type in addition to the non-contact type.

The support member 127 is fixed to the main body part 140 and supports a thermostat 129. The thermostat 129 contacts with the inner peripheral surface of the metal belt 102, and turns on an inner switch when the metal belt 102 comes to have a specified temperature (for example, 200° C.). When the inside switch of the thermostat 129 is turned ON, the fixing device 100 interrupts energization to the IH coil 110, and suppresses the excessive temperature rising of the metal belt 102.

The pressure pad 116 is made of a resin and has elasticity. The pressure pad 116 presses the metal belt 102 to the pressure roller 104 side from the inside of the metal belt 102.

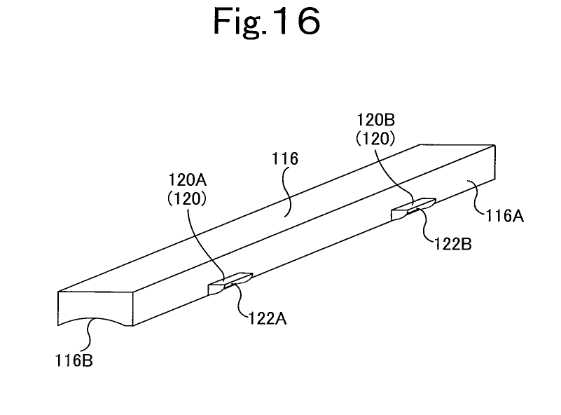

FIG. 16 is a perspective view showing the pressure pad 116.

The pressure pad 116 has a press surface 116B to press the metal belt 102 to the pressure roller 104 side, and a side surface 116A perpendicular to the press surface 116B. A pair of opposite parts 120 (120A, 120B) protrude from the side surface 116A.

The opposite part 120 has hardness higher than that of the pressure pad 116. The opposite parts 120 are formed integrally with the pressure pad 116. The opposite part 120 is opposite to the peeling member 125 through the metal belt 102, and guides the metal belt 102 from the inside. The respective opposite parts 120 include curved surfaces 122A and 122E to guide the metal belt 102.

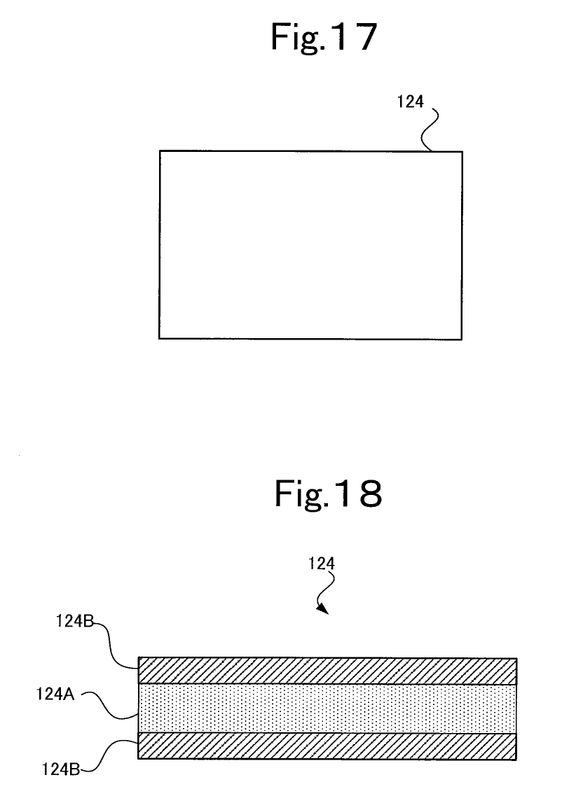

A pair of the peeling members 125 are provided, and the respective peeling members 125 are opposite to the respective opposite parts 120 through the metal belt 102 on the outlet side (downstream side of the metal belt 102 in the rotation direction) of the nip 107. The peeling members 125 are separate from the outer peripheral surface of the metal belt 102 through a gap, and peel the sheet P from the metal belt 102. Each of the peeling members 125 includes a peeling plate 124 and a bracket 126 fixed to the peeling plate 124. The tip of the peeling plate 124 is separate from the outer peripheral surface of the metal belt 102 through the gap. The peeling plate 124 has a rectangular shape, when viewed in a plane, having a size corresponding to the opposite part 120 (FIG. 17). Besides, the peeling plate 124 includes a base member 124A and protection layers 124B laminated on the base member 124A. The protection layer 124B may be made of fluorine resin such as PFA or DLC (Diamond-like Carbon). The protection layer 124B improves the strength of the peeling plate 124.

The coupling member 130 is made of, for example, resin or metal, and a pair of the coupling members are provided correspondingly to the peeling members 125. One end of the coupling member 130 is coupled to an end of the base member 114 in the longitudinal direction, and the other end is coupled to the bracket 126 of the peeling member 125. The coupling members 130 are coupled to the respective members 114 and 126 by, for example, screws. Surfaces of the respective ends of the coupling members 130 are struck against positioning members G1 and G2 attached to the respective members 114 and 126 and are positioned. The positioning positions of the coupling members 130 by the respective positioning members G1 and G2 are set at positions where the gap between the outer peripheral surface of the metal belt 102 and the respective peeling members 125 becomes a specified size (for example, 0.3 mm). The coupling member 130 couples the peeling member 125 and the base member 114, and supports the peeling member 125.

As stated above, in this embodiment, since the sheet P is peeled from the metal belt 102 by the peeling member 125 separate from the outer peripheral surface of the metal belt 102, there is no fear that the outer peripheral surface of the metal belt 102 is damaged by the peeling member 125. Besides, since the peeling member 125 is attached to the base member 114, which is fixed to the housing 106, through the coupling member 130, the gap between the metal belt 102 and the peeling member 125 can be set to the specified size by merely attaching the peeling member 125 to the base member 114. Here, in this embodiment, although the peeling member 125 is attached to the base member 114, it is conceivable that the peeling member is attached to the housing. Then, it is conceivable that the attachment position of the peeling member to the housing is adjusted while a gap gage is inserted into and drawn from the gap between the metal belt and the peeling member. As compared with the above case, in this embodiment, since it is not necessary to adjust the attachment position of the peeling member 125, the peeling member 125 can be easily attached to the fixing device 100. In addition, since the hardness of the opposite part 120 is higher than the hardness of the pressure pad 116, the opposite part 120 can guide the metal belt 102 at a specific position, and the gap between the outer peripheral surface of the metal belt 102 and the peeling member 125 can be kept at the specified size for a long period.

Incidentally, the fixing device 100 includes, in addition to the respective members, a cleaning roller to remove toner, dirt and dust attached to the outer peripheral surface of the metal belt 102, and an oil roller to facilitate peeling of the sheet P from the outer peripheral surface of the metal belt 102.

Hereinafter, the control of the fixing device 100 by the processor 801 and the control of the whole image forming apparatus 200 will be described.

When the image forming apparatus 200 is turned on, the processor 801 starts warming-up of the image forming apparatus 200. That is, the processor 801 rotates the pressure roller 104, and rotates the metal belt 102. Besides, the processor 801 monitors the surface temperature of the metal belt 102 by the temperature sensor 118, and heats the metal belt 102 by the IH coil 110 so that the entire area of the metal belt 102 just before the nip 107 in the main scanning direction (longitudinal direction of the metal belt 102) comes to have a specified temperature. At this time, the processor 801 changes electric power supplied to the IH coil 110 by changing the amount of voltage (amount of current) supplied to the IH coil 110 or the frequency of voltage (current).

When the temperature of the metal belt 102 becomes the specified temperature, the processor 801 terminates the warming-up of the image forming apparatus 200. The specified temperature is the temperature suitable for fixing the toner T to the sheet P by the metal belt 102. When the sheet P as the image forming process object is thick, the transfer amount of the toner T onto the sheet P is required to be large, and a large heat amount is required for the fixing process of the toner T. Thus, when the sheet P as the image forming process object is thick, the processor 801 sets the specified temperature to be high.

When terminating the warming-up of the image forming apparatus 200, the processor 801 brings the image forming apparatus into a standby state, and keeps the temperature of the metal belt 102 at the specified temperature. Then, the processor 801 performs, for example, the copy process described in the first embodiment.

In the copy process, when the sheet P is conveyed to the fixing device 100, the processor 801 rotates the pressure roller 104. Then, the pressure roller 104 and the metal belt 102 having the specified temperature heat and press the sheet P at the nip 107, and fixes the toner T to the sheet P. At this time, in general, the toner T on the sheet P is peeled from the surface of the metal belt 102 after passing through the nip 107. However, when the amount of the toner T is large, or the melting temperature of the toner T is high, even if the toner T passes through the nip 107, the toner remains attached to the surface of the metal belt 102, and there is a case where the sheet P is wound around the metal belt 102 by the toner T. In this case, the peeling member 125 peels the sheet P from the metal belt 102.

The processor 801 conveys the sheet P, on which the toner T is heated and fixed by the fixing device 100 as described above, by plural conveyance roller pairs in the image forming apparatus 200, and sequentially discharges it onto the discharge tray 8.

Incidentally, when the temperature of the metal belt 102 does not reach the specified temperature within a specified time from the start of warming-up, the processor 801 determines that abnormality occurs, and stops the warming-up. The processor 801 causes the operation display section 805 to display a screen for urging a serviceman to check the image forming apparatus 200.

### Modified Examples of the Sixth Embodiment

In the sixth embodiment, the opposite part 120 has the hardness higher than that of the pressure pad 116 and is formed integrally with the pressure pad 116. However, the opposite part has the hardness higher than that of the pressure pad 116, and may be formed integrally with the base member (may be supported by the base member). By doing so, the opposite part can more certainly guide the metal belt at the constant position, and can keep the gap between the metal belt and the peeling member at the specified size.

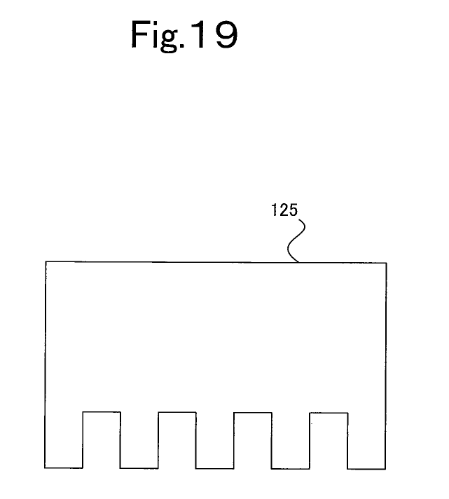

In this embodiment, although the peeling member 125 has the rectangular shape when viewed in a plane, the peeling member 125A may have a comb shape when viewed in a plane as shown in FIG. 19.

In the sixth embodiment, although the description is made on the example in which the heating apparatus is the fixing device, a color erasing device can also be used as the heating apparatus. When the color erasing device is used as the heating apparatus, the color erasing device erases a toner image by heating and pressing a sheet fixed with color erasable toner which is erased by heating.

In the sixth embodiment, although the description is made on the example in which the heating unit heats the belt, the heating unit may heat the pressure roller.

According to the sixth embodiment, for example, techniques of the following (1) to (15) can be provided.

(1) A heating apparatus includes a rotator, an endless belt that is rotated by rotation of the rotator, and nips and conveys a sheet on which toner is transferred in cooperation with the rotator, a heating unit to heat at least one of the rotator and the belt, a press member to press the belt to the rotator side from the inside of the belt, a base member that is positioned in an inside space of the belt and supports the press member, a peeling member that is separate from an outer peripheral surface of the belt through a gap and peels the sheet from the belt, and a coupling member to couple the peeling member and the base member.

(2) In the heating apparatus of (1), an opposite part that is opposite to the peeling member through the belt and guides the belt from the inside is provided.

(3) In the heating apparatus of (2), the opposite part has hardness higher than that of the press member and is integral with the base member.

(4) In the heating apparatus of (3), the peeling member has a plate shape when viewed in a plane.

(5) In the heating apparatus of (4), the peeling member includes a base member and a protection layer laminated on the base member.

(6) In the heating apparatus of (5), the base member has a longish shape extending in a width direction of the belt at the inside of the belt, and supports the coupling member at both ends.

(7) In the heating apparatus of (6), the heating unit heats the belt.

(8) An image forming apparatus includes an image forming section that transfers toner onto a sheet and forms an image, a rotator, an endless belt that is rotated by rotation of the rotator and nips and conveys the sheet, on which the toner is transferred by the image forming section, in cooperation with the rotator, a heating unit to heat at least one of the rotator and the belt, a press member to press the belt to the rotator side from the inside of the belt, a base member that is positioned in an inside space of the belt and supports the press member, a peeling member that is separate from an outer peripheral surface of the belt through a gap and peels the sheet from the belt, and a coupling member to couple the peeling member and the base member.

(10) In the image forming apparatus of (9), an opposite part that is opposite to the peeling member through the belt and guides the belt from the inside is provided.

(11) In the image forming apparatus of (10), the opposite part has hardness higher than that of the press member and is integral with the base member.

(12) In the image forming apparatus of (11), the peeling member has a plate shape when viewed in a plane.

(13) In the image forming apparatus of (12), the peeling member includes a base member and a protection layer laminated on the base member.

(14) In the image forming apparatus of (13), the base member has a longish shape extending in a width direction of the belt at the inside of the belt, and supports the coupling member at both ends.

(15) In the image forming apparatus of (14), the heating unit heats the belt.

The invention can be carried out in various forms without departing from the spirit or the principle feature of the invention. Accordingly, the foregoing embodiments are merely examples in any points and should not be interpreted in a limiting sense. The scope of the invention is described by the claims and is not limited by the contents of the specification. Further, all modifications, various improvements, substitutions and alterations belonging to the equivalent range of the claims are contained within the scope of the invention.

As described above in detail, according to the technique disclosed in the specification, the technique to improve the equalizing temperature

performance in the temperature equalizing roller can be provided.

While certain embodiments have been described, these embodiments have been presented by way of example only, and are not intended to limit the scope of invention. Indeed, the novel apparatus described herein may be embodied in a variety of other forms; furthermore, various omissions, substitutions and changes in the form of the apparatus described herein may be made without departing from the spirit of the inventions. The accompanying claims and their equivalents are intended to cover such forms or modifications as would fall within the scope and spirit of the inventions.

What is claimed is:

1. A temperature equalizing roller comprising:
a metal pipe;
a heat pipe that is located inside the metal pipe and comprises a thermal expansion coefficient higher than a thermal expansion coefficient of the metal pipe; and
a joining layer that lies between an outer peripheral surface of the heat pipe and an inner peripheral surface of the metal pipe, joins the outer peripheral surface of the heat pipe and the inner peripheral surface of the metal pipe, and comprises a higher thermal conductivity than a higher thermal conductivity of air.

2. The roller of claim 1, wherein an inner peripheral length of the metal pipe is longer than a peripheral length of a circle comprising a radius equal to an average inner radius of the metal pipe.

3. The roller of claim 2, wherein the inner peripheral surface of the metal pipe is provided with a plurality of grooves extending in axial direction of the metal pipe.

4. The roller of claim 3, wherein the joining layer is made of a solder.

5. The roller of claim 4, further comprising a heater configured to heat a sheet on which toner is transferred,
wherein
the heat pipe equalizes temperature unevenness generated on the heater,
the joining layer includes regions separate from each other and positioned near both ends of the temperature equalizing roller in an axial direction,
a distance between ends of both the areas of the joining layer positioned separate from each other and near a center in the axial direction is shorter than a size, in the axial direction, of a minimum sheet heated by the heater, and a distance between outside ends of both the areas is larger than a size, in the axial direction, of a maximum sheet heated by the heater.

6. The roller of claim 5, wherein the joining layer includes silver as an additive.

7. The roller of claim 6, wherein the heat pipe includes a surface protection member in which a thermal conductivity at both end sides in an axial direction of the heat pipe is higher than a thermal conductivity at a center part.

8. The roller of claim 7, wherein a thickness of the metal pipe at a center part is thicker than a thickness at both ends in the axial direction of the metal pipe.

9. A temperature equalizing roller comprising:
a metal pipe that comprises a tubular shape and comprises an inner peripheral length longer than a peripheral length of a circle comprising a radius equal to an average inner radius; and
a heat pipe that is in close contact with an inner peripheral surface of the metal pipe and comprises a thermal expansion coefficient higher than a thermal expansion coefficient of the metal pipe.

10. The roller of claim 9, wherein the inner peripheral surface of the metal pipe is provided with a spiral groove.

11. The roller of claim 9, wherein the inner peripheral surface of the metal pipe is provided with a plurality of grooves extending in an axial direction of the metal pipe.

12. The roller of claim 11, wherein the heat pipe includes a surface protection member in which a thermal conductivity at both end sides in an axial direction of the heat pipe is higher than a thermal conductivity at a center part.

13. The roller of claim 12, wherein a thickness of the metal pipe at a center part is thicker than a thickness at both ends in the axial direction of the metal pipe.

14. A fixing device comprising:
a metal pipe of any of a heating rotator to heat a sheet on which toner is transferred, a rotator to feed the sheet in cooperation with the heating rotator, or a rotator to rotate a belt wound around the rotator and the heating rotator;
a heat pipe that is located inside the metal pipe and comprises a thermal expansion coefficient higher than a thermal expansion coefficient of the metal pipe; and
a joining layer that lies between an outer peripheral surface of the heat pipe and an inner peripheral surface of the metal pipe, joins the outer peripheral surface of the heat pipe and the inner peripheral surface of the metal pipe, and comprises a higher thermal conductivity than a thermal conductivity of air.

15. The device of claim 14, wherein an inner peripheral length of the metal pipe is longer than a peripheral length of a circle comprising a radius equal to an average inner radius of the metal pipe.

16. The device of claim 15, wherein the inner peripheral surface of the metal pipe is provided with a plurality of grooves extending in an axial direction of the metal pipe.

17. The device of claim 16, wherein the joining layer is made of a solder.

18. The device of claim 17, wherein
the joining layer includes regions separate from each other and positioned near both ends of the heat pipe in an axial direction,
a distance between ends of both the areas of the joining layer positioned separate from each other and near a center in the axial direction is shorter than a size, in the axial direction, of a minimum sheet as a toner fixing process object, and a distance between outside ends of both the areas is larger than a size, in the axial direction, of a maximum sheet as a toner fixing process object.

19. The device of claim 18, wherein the joining layer includes silver as an additive.

20. The device of claim 19, wherein the heat pipe includes a surface protection member in which a thermal conductivity at both end sides in the axial direction of the heat pipe is higher than a thermal conductivity at a center part.
